(19) United States
(12) Patent Application Publication
(10) Pub. No.: US 2026/0211112 A1
(43) Pub. Date: Jul. 23, 2026

(54) METHOD FOR MEASURING DISTANCE BETWEEN TWO POINTS IN SPACE USING HANDHELD LASER RANGEFINDER

(71) Applicant: SNDWAY TECHNOLOGY (GUANGDONG) CO., LTD., Dongguan (CN)

(72) Inventors: Wu LIANG, Dongguan (CN); Gang HE, Dongguan (CN)

(21) Appl. No.: 19/031,202

(22) Filed: Jan. 17, 2025

(51) Int. Cl. G01S 17/48; G01C 25/00; G01P 15/18; G01P 21/00; G01S 7/481

(52) U.S. Cl. CPC G01S 17/48; G01C 25/00; G01P 15/18; G01P 21/00; G01S 7/4814; G01S 7/4816

(57) ABSTRACT

A method for measuring a distance between two points in space using a handheld laser rangefinder includes configuring an accelerometer and a gyroscope in the handheld laser rangefinder, and acquiring pitch angles, angular velocity and translational acceleration of the handheld laser rangefinder when measuring through the accelerometer and the gyroscope; aiming the handheld laser rangefinder at a first target point to obtain a first measured distance between the handheld laser rangefinder and the first target point and obtain a first pitch angle of the handheld laser rangefinder when measuring the first measured distance through the gyroscope. The method effectively solves the problem of large measurement error caused by inaccurate azimuth angle under the condition that the body of the handheld laser rangefinder is not horizontal, and improves the measurement accuracy of the handheld laser rangefinder.

### TECHNICAL FIELD

The disclosure relates to the technical field of laser ranging, and more particularly, to a method for measuring a distance between two points in space using a handheld laser rangefinder.

### BACKGROUND

During the measurement process of laser rangefinder, since light travels in a straight line, the measurement result is most accurate when the laser is emitted at a 0° angle to a target. However, in the case of a handheld laser rangefinder, it is difficult to place the handheld laser rangefinder horizontally during measurement. Additionally, any shaking or movement during the measurement process can affect the accuracy. Therefore, with traditional handheld laser rangefinders, in order to obtain highly accurate measurement results, auxiliary tools such as tripods are often required to position the handheld laser rangefinder as horizontally as possible, making it inconvenient to use and failing to achieve the intended purpose and effect of handheld measurement.

Currently, some laser rangefinder manufacturers have incorporated gyroscopes into their devices. By directly reading the gyroscope's angle data, they obtain the offset angle of the rangefinder to measure the distance between two points in space. However, when measuring the distance between two points in space, the measurement location forms a spatial triangular configuration with the target points. The process involves first measuring the distance from the measurement point to the first point, then measuring the distance from the measurement point to the second point. During handheld measurements, the laser rangefinder may tilt in multiple directions. To account for this, the rotation angle from the first point to the second point is obtained using the gyroscope, and the distance between the first and second points is calculated using trigonometric functions. Since tilting occurs during the measurement, it affects the accuracy of the azimuthal rotation angle, and the larger the tilt angle, the greater the error in the azimuthal angle, leading to an issue with measurement accuracy.

Therefore, a method for measuring a distance between two points in space using a handheld laser rangefinder is proposed.

### SUMMARY

To address the aforementioned drawbacks in the prior art, the disclosure provides a method for measuring a distance between two points in space using a handheld laser rangefinder, solving the technical problems raised in the background.

To achieve the above objective, the disclosure is implemented through the following technical solutions.

In a first aspect, a method for measuring a distance between two points in space using a handheld laser rangefinder, includes:
step 1: configuring an accelerometer and a gyroscope within the handheld laser rangefinder, and obtaining angular velocity and translational acceleration of the handheld laser rangefinder during measurement via the accelerometer and the gyroscope;
step 2: aiming the handheld laser rangefinder at a first target point and determining a distance between the handheld laser rangefinder and the first target point: a first measured distance;
step 3: rotating the handheld laser rangefinder toward a second target point and determining a distance between the handheld laser rangefinder and the second target point: a second measured distance;
step 4: during the rotation of the handheld laser rangefinder, acquiring angular velocity data and acceleration data in real time from the gyroscope and the accelerometer, integrating the angular velocity data and the acceleration data, and transforming a coordinate system of the handheld laser rangefinder into a reference coordinate system;
where the coordinate system of the handheld laser rangefinder is obtained from the acceleration sensor (also referred to as accelerometer); acceleration values are obtained from the acceleration sensor to calculate an angle between the coordinate system of the handheld laser rangefinder and the reference coordinate system; a rotation matrix is used to obtain values of the handheld laser rangefinder in the reference coordinate system, including a first pitch angle and a first yaw angle of the first target point, and a second pitch angle and a second yaw angle of the second target point; a difference between the first yaw angle and the second yaw angle is calculated as an azimuth angle (i.e., relative azimuth angle); and after obtaining values of the reference coordinate system, the first pitch angle, the second pitch angle, and the azimuth angle are mapped into the reference coordinate system through coordinate transformation to obtain a first pitch angle, a second pitch angle, and an azimuth angle in the reference coordinate system; and
step 5: calculating, using trigonometric principles, a distance between the first target point and the second target point.

In an embodiment, step 4 includes:
S1: reading data from the gyroscope and the accelerometer, and storing the gyroscope data and the accelerometer data in a register;
S2: processing the accelerometer data;
S3: processing the gyroscope data;
S4: compensating the gyroscope using the accelerometer data;
S5: calculating a quaternion;
S6: calculating a rotation matrix r to obtain calculated rotation matrix data;
S7: feeding the calculated rotation matrix data back to S4 and repeating S4 to S6 to calculate multiple rotation matrix data results, and storing the multiple rotation matrix data results;
S8: obtaining a quaternion when measuring the first target point and calculating Euler angles of the first target point, including the first roll angle, the first pitch angle, and the first yaw angle;
obtaining the quaternion updated by S7 when measuring the second target point, and calculating Euler angles of the second target point, including the second roll angle, the second pitch angle, and the second yaw angle; and
determining a difference between the first yaw angle and the second yaw angle as the azimuth angle.

In an embodiment, S4 includes:
S41: calculating a difference between a direction read by the accelerometer and a direction of gravitational acceleration using a vector cross-product method;
S42: multiplying the calculated difference from S41 by an integration constant and performing error accumulation; and
S43: correcting a gyroscope drift using a cross-product error to offset a drift in gyroscope readings.

In an embodiment, S5 includes:
S51: integrating a discretized form of a quaternion kinematic equation using a first-order approximation algorithm to obtain the quaternion; and
S52: unitizing the quaternion using a normalization algorithm.

In an embodiment, S8 includes:
obtaining a quaternion updated by S7 when measuring the distance of the second target point;
calculating Euler angles, including a roll angle, a pitch angle, and a yaw angle; and
determining the yaw angle as an azimuth angle.

In an embodiment, step 5 includes:
(a) constructing a reference coordinate system using a spatial coordinate system (X, Y, Z) and mapping obtained measurement data into the reference coordinate system;
(b) calculating a horizontal distance between the handheld laser rangefinder and the first target point, a vertical distance of the first target point relative to plane coordinates (also referred to as vertical distance between the first target point and the plane coordinates), a horizontal distance between the handheld laser rangefinder and the second target point, and a vertical distance of the second target point relative to the plane coordinates;
(c) determining the azimuth angle in the reference coordinate system as an angle between the horizontal distance from the handheld laser rangefinder to the first target point and the horizontal distance from the handheld laser rangefinder to the second target point, and calculating a horizontal distance between the first target point and the second target point according to trigonometric functions; and
(d) calculating a spatial distance between the first target point and the second target point based on a height difference between the first target point and the second target point.

In an embodiment, step (a) includes: mapping the horizontal distance between the handheld laser rangefinder and the first target point, the horizontal distance between the handheld laser rangefinder and the second target point, the horizontal distance between the first target point and the second target point, the first measured distance and the first pitch angle between the handheld laser rangefinder and the first target point, and the second measured distance and the second pitch angle between the handheld laser rangefinder and the second target point into the reference coordinate system.

In an embodiment, step (b) includes: based on the first measured distance and the first pitch angle between the handheld laser rangefinder and the first target point, and the second measured distance and the second pitch angle between the handheld laser rangefinder and the second target point, calculating, using trigonometric functions, the horizontal distance between the handheld laser rangefinder and the first target point, the vertical distance between the first target point and the plane coordinates, the horizontal distance between the handheld laser rangefinder and the second target point, and the vertical distance between the second target point and the plane coordinates.

In an embodiment, step (d) includes: because there may be a height difference between the first target point and the second target point, the height difference, the horizontal distance between the first target point and the second target point and the distance between the first target point and the second target point form a right triangle, so as to calculate the actual distance between the first target point and the second target point (also referred to as the spatial distance between the first target point and the second target point) according to the properties of the right triangle.

In a second aspect, a handheld laser rangefinder includes: a laser ranging module, a gyroscope module, an accelerometer module, and a processor module; and the processor module is embedded with the method for measuring the distance between the two points in space, and configured to measure the distance between the two points in space.

By adopting the technical solution provided by the disclosure, compared with common knowledge, the following beneficial effects are achieved.

The disclosure provides the method for measuring the distance between two points in space using the handheld laser rangefinder. By configuring the accelerometer and the gyroscope in the handheld laser rangefinder, the accelerometer measures acceleration, and the gyroscope provides angular velocity, and the angular velocity and the acceleration are combined. Before calculating the azimuth angle, the coordinate system of the handheld laser rangefinder is transformed to the reference coordinate system. The coordinate system of the handheld laser rangefinder is obtained by the acceleration sensor, and the acceleration values obtained from the acceleration sensor are used to calculate the angle between the coordinate system of the handheld laser rangefinder and the reference coordinate system. The rotation matrix is then used to obtain the values of the handheld laser rangefinder in the reference coordinate system. After obtaining the values in the reference coordinate system, the yaw angle is mapped and transformed into the reference coordinate system, yielding the azimuth angle in the reference coordinate system. Then, based on the distance measured by the laser rangefinder, combined with the azimuth angle and other data, the distance between the two points in space is calculated. This method effectively solves the problem of measurement errors due to inaccurate azimuth angles when the body of the rangefinder is not level, thereby improving the measurement accuracy of the handheld laser rangefinder.

The handheld laser rangefinder mentioned in the disclosure is not limited to portable handheld laser rangefinders or laser ranging telescopes; it can also be applied to other devices equipped with laser ranging capabilities.

### BRIEF DESCRIPTION OF DRAWINGS

In order to more clearly illustrate the technical solutions of the embodiments of the disclosure or prior art, a brief introduction to the accompanying drawings that are needed in the description of the embodiments or prior art is provided below. It is apparent that the accompanying drawings described below are merely some embodiments of the disclosure, and to those skilled in the art, additional drawings may be obtained from these without requiring any inventive effort.

FIG. 1 illustrates a schematic flowchart of a method for measuring a distance between two points in space using a handheld laser rangefinder.

FIG. 2 illustrates a schematic diagram of a process for calculating a distance between two points based on a reference coordinate system in the disclosure.

FIG. 3 illustrates a schematic diagram of a handheld laser rangefinder in the disclosure.

### DETAILED DESCRIPTION OF EMBODIMENTS

To make the objectives, technical solutions, and advantages of the disclosure clearer, the following description will provide a clear and complete description of the technical solutions of the disclosure's embodiments with reference to the accompanying drawings. It is apparent that the described embodiments are part of the embodiments of the disclosure and not all of them. All other embodiments derived by those skilled in the art, without inventive effort, based on the embodiments of the disclosure, fall within the protection scope of the disclosure.

The disclosure will be further described below with reference to the embodiments.

### Embodiment 1

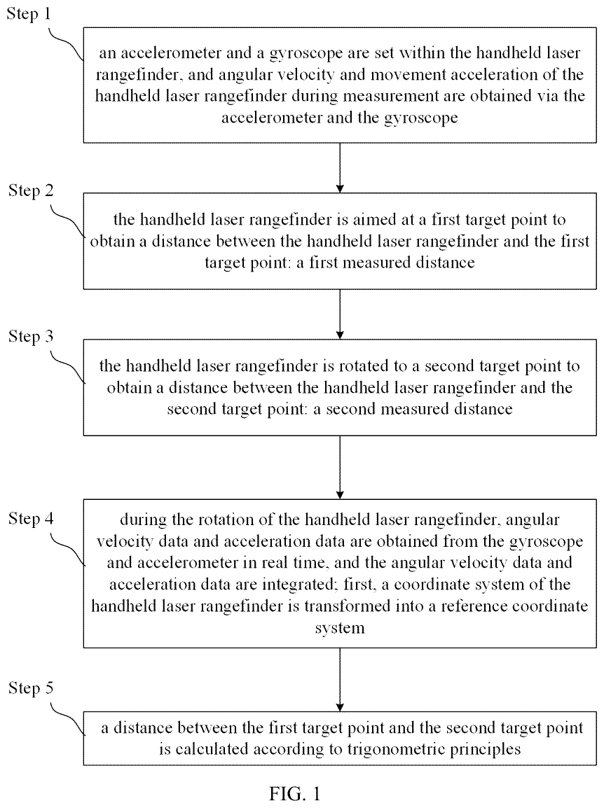

A method for measuring a distance between two points in space (also referred to as spatial distance between two points) using a handheld laser rangefinder (also referred to as handheld laser distance meter), as shown in FIG. 1, includes the following steps 1 to 5.

Step 1: an accelerometer and a gyroscope are set within the handheld laser rangefinder, and angular velocity and translational acceleration of the handheld laser rangefinder during measurement are obtained via the accelerometer and the gyroscope.

Step 2: the handheld laser rangefinder is aimed at a first target point to obtain a distance between the handheld laser rangefinder and the first target point: a first measured distance.

Step 3: the handheld laser rangefinder is rotated to a second target point to obtain a distance between the handheld laser rangefinder and the second target point: a second measured distance.

Step 4: during the rotation of the handheld laser rangefinder, angular velocity data and acceleration data are obtained from the gyroscope and the accelerometer in real time, and the angular velocity data and acceleration data are integrated; first, a coordinate system of the handheld laser rangefinder is transformed into a reference coordinate system.

The coordinate system of the handheld laser rangefinder is obtained by the acceleration sensor, and the acceleration values from the acceleration sensor are used to calculate the angle between the handheld laser rangefinder's coordinate system and the reference coordinate system. Then, using a rotation matrix, the values of the handheld laser rangefinder in the reference coordinate system are obtained, including a first pitch angle and a first yaw angle of the first target point, a second pitch angle and a second yaw angle of the second target point. The difference between the first yaw angle and the second yaw angle is taken as an azimuth angle. After obtaining the values in the reference coordinate system, the first pitch angle, the second pitch angle, and the azimuth angle are mapped through coordinate transformation into the reference coordinate system to obtain the first pitch angle, the second pitch angle, and the azimuth angle in the reference coordinate system.

Step 4 specifically includes the following steps S1 to S8.

S1: the gyroscope data and accelerometer data are read, and the gyroscope data and accelerometer data are stored in a register.

S2: the accelerometer data is processed.

S3: the gyroscope data is processed.

S4: the gyroscope is compensated using the accelerometer data.

S5: the quaternion is calculated.

S6: the rotation matrix r is calculated.

S7: the calculated rotation matrix results are fed back into S4, S4-S6 are repeated to calculate multiple rotation matrix result data, and store them.

S8: the azimuth angle is calculated.

S4 specifically includes S41 to S43.

S41: the vector cross-product method is used to calculate the difference between the direction read by the accelerometer and the direction of gravitational acceleration.

S42: the difference calculated in S41 is multiplied by the integration constant and the error is accumulated.

S43: the cross-product error is used to correct the gyroscope offset and counteract the offset in the gyroscope readings.

S5 specifically includes S51 and S52.

S51: a first-order approximation algorithm is used to integrate the discretized form of the quaternion kinematic equation to obtain the quaternion.

S52: a normalization algorithm is applied to unitize the quaternion.

S8 specifically includes:
obtaining the quaternion for the first target point and calculating the Euler angles for the first target point: the first roll angle, the first pitch angle, and the first yaw angle; and
obtaining a quaternion updated by S7 when measuring the distance of the second target point and calculating the Euler angles for the second target point: the second roll angle, the second pitch angle, and the second yaw angle;
where the difference between the first yaw angle and the second yaw angle obtained is the azimuth angle.

Step 5: a distance between the first target point and the second target point is calculated according to trigonometric principles.

Step 5 specifically includes the following steps (a) to (d).

Step (a): a reference coordinate system is constructed using a spatial coordinate system (X, Y, Z), and the obtained measurement data is mapped onto the reference coordinate system.

Step (b): the horizontal distance between the handheld laser rangefinder and the first target point, the vertical distance between the first target point and the plane coordinates, the horizontal distance between the handheld laser rangefinder and the second target point, and the vertical distance between the second target point and the plane coordinates are calculated.

Step (c): in the reference coordinate system, the angle between the horizontal distance between the handheld laser rangefinder and the first target point and the horizontal distance between the handheld laser rangefinder and the second target point is the azimuth angle. Using trigonometric functions, the horizontal distance between the first and second target points is calculated.

Step (d): the spatial distance between the first and second target points is calculated based on the height difference between the first and second target points.

Step (a) specifically includes: mapping the horizontal distance between the handheld laser rangefinder and the first target point, the horizontal distance between the handheld laser rangefinder and the second target point, the horizontal distance between the first and second target points, the first measured distance from the handheld laser rangefinder to the first target point, and the first pitch angle, as well as the second measured distance from the handheld laser rangefinder to the second target point and the second pitch angle, into the reference coordinate system.

Step (b) specifically includes: based on the first measured distance from the handheld laser rangefinder to the first target point and the first pitch angle, and the second measured distance from the handheld laser rangefinder to the second target point and the second pitch angle, calculating using trigonometric functions: the horizontal distance between the handheld laser rangefinder and the first target point, the vertical distance between the first target point and the plane coordinates, the horizontal distance between the handheld laser rangefinder and the second target point, and the vertical distance between the second target point and the plane coordinates.

Step (d) specifically includes: since there may be a height difference between the first and second target points, the height difference, the horizontal distance between the first and second target points, and the distance between the first and second target points form a right triangle. Based on the properties of right triangles, the actual distance between the first and second target points is calculated.

In this embodiment, the method provided above offers a novel approach for measuring the spatial distance between two points with the handheld laser rangefinder.

### Embodiment 2

A method for measuring a distance between two points in space using a handheld laser rangefinder is provided, an accelerometer and a gyroscope are set in the handheld laser rangefinder to acquire the acceleration measured by the accelerometer and the angular velocity obtained from the gyroscope. By combining the angular velocity and the acceleration, before calculating the azimuth angle, the coordinate system of the handheld laser rangefinder is transformed into a reference coordinate system. The coordinate system of the handheld laser rangefinder is obtained from the acceleration sensor, which provides the acceleration values. The angle between the handheld laser rangefinder's coordinate system and the reference coordinate system is then calculated. A rotation matrix is used to derive the values of the handheld laser rangefinder in the reference coordinate system. After obtaining the values in the reference coordinate system, the azimuth angle is mapped and transformed into the reference coordinate system, thus obtaining the azimuth angle in the reference coordinate system. Based on the distance measured by the handheld laser rangefinder, along with the azimuth angle and other data, the spatial distance between the two points is calculated. This method solves the issue of significant measurement errors caused by inaccurate azimuth angles when the body of the handheld laser rangefinder is not level.

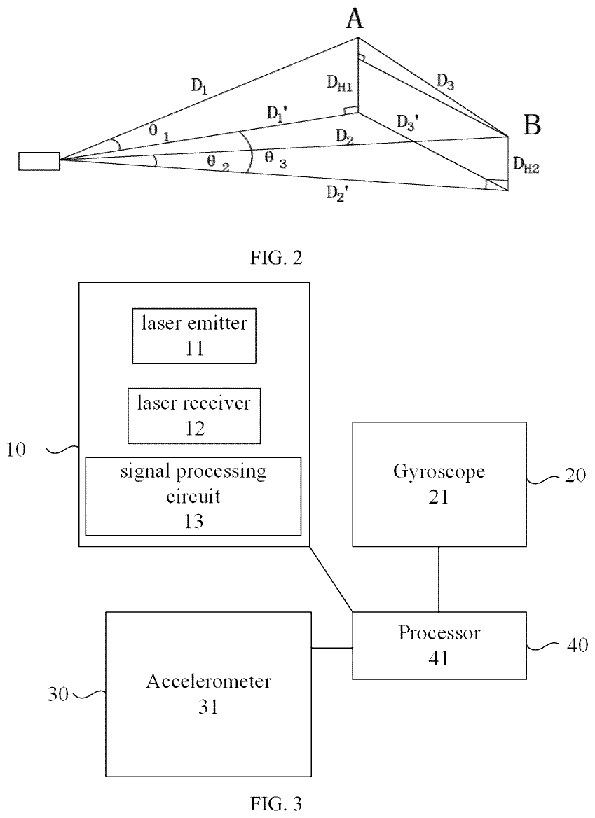

Referring to FIG. 2, a method for measuring a distance between two points in space using a handheld laser rangefinder according to the disclosure includes the following steps: aligning the laser rangefinder to a first target point to acquire a measured distance D₁ between the laser rangefinder and the first target point, and obtaining a pitch angle θ₁ of the laser rangefinder during the measurement of the first target point via a gyroscope; rotating the laser rangefinder to a second target point to acquire a measured distance D₂ between the laser rangefinder and the second target point, and obtaining a pitch angle θ₂ of the laser rangefinder during the measurement of the second target point via the gyroscope; simultaneously, during the rotation of the laser rangefinder, acquiring a spatial azimuth angle of the laser rangefinder from the first target point to the second target point via the gyroscope and the accelerometer; then mapping and transforming the spatial azimuth angle into an azimuth angle θ₃ in the reference coordinate system; and finally, calculating the distance D₃ between the first target point and the second target point based on trigonometric functions.

The method for obtaining the azimuth angle θ₃ includes the following steps (1) to (8).

Step (1): the gyroscope data (also referred to as angular velocity data) gₓ, g_{y}, g_{z} and accelerometer data (also referred to as acceleration data) aₓ, a_{y}, a_{z} are read and stored in a register.

Step (2): the accelerometer data aₓ, a_{y}, a_{z} are processed; and step (2) specifically include:
(2.1) performing zero drift calibration on the acquired accelerometer data to obtain calibrated accelerometer data;
(2.2) normalizing the calibrated accelerometer data by multiplying the calibrated accelerometer data by the gravitational acceleration g (9.8 m/s²) to obtain:

$${a}_{x} = {a}_{x} \times g , {a}_{y} = {a}_{y} \times g ; {a}_{z} = {a}_{z} \times g ;$$

(2.3) after performing second-order low-pass filtering on the accelerometer data obtained in step (2.2), storing the results in the register.

Step (3): the gyroscope data gₓ, g_{y}, g_{z} are processed; and step (3) specifically includes:
(3.1) performing zero drift calibration on the acquired gyroscope data;
(3.2) normalizing the gyroscope data by converting the gyroscope's angular velocity units from radians per second to degrees per second; here, 1 radian/second-57.3 degrees/second;
(3.3) after performing second-order low-pass filtering on the gyroscope data obtained in step (3.2), storing the results in the register.

Step (4): the gyroscope is compensated by acceleration; and step (4) specifically includes:
(4.1) using the vector cross-product method to calculate differences between the accelerometer reading directions and the gravitational acceleration direction, resulting in eₓ, e_{y}, e_{z}, where:

$${e}_{x} = {a}_{y} \times r M a t [ 2 ] [ 2 ] - {a}_{z} \times r M a t [ 2 ] [ 1 ] ;$$

$${e}_{y} = {a}_{z} \times r M a t [ 2 ] [ 0 ] - {a}_{x} \times r M a t [ 2 ] [ 2 ] ;$$

$${e}_{z} = {a}_{x} \times r M a t [ 2 ] [ 1 ] - {a}_{y} \times r M a t [ 2 ] [ 0 ] ;$$

where rMat[2][0], rMat[2][1], rMat[2][2] are the elements in the first, second and third columns of the third row in the gravitational rotation matrix, initially set to 0;
(4.2) multiplying the differences eₓ, e_{y}, e_{z} from step (4.1) by the integral constant to obtain eₓInt, e_{y}Int, e_{z}Int and accumulating the errors, where:

$${e}_{x} Int = {e}_{x} Int + Ki \times {e}_{x} \times dt ;$$

$${e}_{y} Int = {e}_{y} Int + Ki \times {e}_{y} \times dt ;$$

$${e}_{z} Int = {e}_{z} Int + Ki \times {e}_{z} \times dt ;$$

Then:

$${g}_{x} = {g}_{x} + {e}_{x} Int ;$$

$${g}_{y} = {g}_{y} + {e}_{y} Int ;$$

$${g}_{z} = {g}_{z} + {e}_{z} Int ;$$

(4.3) correcting a gyroscope drift using a cross-product error to offset a drift in gyroscope readings:

$${g}_{x} = {g}_{x} + {e}_{x} Int + Kp \times {e}_{x} ;$$

$${g}_{y} = {g}_{y} + {e}_{y} Int + Kp \times {e}_{y} ;$$

$${g}_{z} = {g}_{z} + {e}_{z} Int + Kp \times {e}_{z} ;$$

where Kp is the proportional gain.

Step (5): the quaternion is calculated; and step (5) specifically includes:
(5.1) using a first-order approximation algorithm to integrate the discrete form of the quaternion kinematic equation, obtaining the quaternion q₀, q₁, q₂, q₃, where:

$${q}_{0} = {q}_{0} + ( - {q}_{1} \times {g}_{x} - {q}_{2} \times {g}_{y} - {q}_{3} \times {g}_{z} ) \times 0.5 \times dt ;$$

$${q}_{1} = {q}_{1} + ( {q}_{0} \times {g}_{x} + {q}_{2} \times {g}_{z} - {q}_{3} \times {g}_{y} ) \times 0.5 \times dt ;$$

$${q}_{2} = {q}_{2} + ( {q}_{0} \times {g}_{y} - {q}_{1} \times {g}_{z} + {q}_{3} \times {g}_{x} ) \times 0.5 \times dt ;$$

$${q}_{3} = {q}_{3} + ( {q}_{0} \times {g}_{z} + {q}_{1} \times {g}_{y} - {q}_{2} \times g x ) \times 0.5 \times dt ;$$

(5.2) normalizing the quaternion using the normalization algorithm:

$$norm = \sqrt{{q}_{0} * {q}_{0} + {q}_{1} * {q}_{1} + {q}_{2} * {q}_{2} + {q}_{3} * {q}_{3}}$$

$${q}_{0} = {q}_{0} \times norm ;$$

$${q}_{1} = {q}_{1} \times norm ;$$

$${q}_{2} = {q}_{2} \times norm ;$$

$${q}_{3} = {q}_{3} \times norm .$$

Step (6): the rotation matrix r is calculated, where:

$$r M a t [ 0 ] [ 0 ] = 1 - 2 \times {q}_{2} \times {q}_{2} - 2 \times {q}_{3} \times {q}_{3} ;$$

$$rMat [ 0 ] [ 1 ] = 2 \times ( {q}_{1} \times {q}_{2} - {q}_{0} \times {q}_{3} ) ;$$

$$rMat [ 0 ] [ 2 ] = 2 \times ( {q}_{1} \times {q}_{3} + {q}_{0} \times {q}_{2} ) ;$$

$$rMat [ 1 ] [ 0 ] = 2 \times ( {q}_{1} \times {q}_{2} + {q}_{0} \times {q}_{3} ) ;$$

$$rMat [ 1 ] [ 1 ] = 1 - 2 \times {q}_{1} \times {q}_{1} - 2 \times {q}_{3} \times {q}_{3} ;$$

$$rMat [ 1 ] [ 2 ] = 2 \times ( {q}_{2} \times {q}_{3} - {q}_{0} \times {q}_{1} ) ;$$

$$rMat [ 2 ] [ 0 ] = 2 \times ( {q}_{1} \times {q}_{3} - {q}_{0} \times {q}_{2} ) ;$$

$$rMat [ 2 ] [ 1 ] = 2 \times ( {q}_{2} \times {q}_{3} + {q}_{0} \times {q}_{1} ) ;$$

$$rMat [ 2 ] [ 2 ] = 1 - 2 \times {q}_{1} \times {q}_{1} - 2 \times {q}_{2} \times {q}_{2} .$$

Step (7): during the movement from the first target point to the second target point, the rangefinder continues to rotate. As a result, the rotation matrix also rotates, and multiple rotation matrix data results is output. The calculated rotation matrix data results are fed back into step (4), and steps (4) through (6) are repeated to calculate multiple rotation matrix results, which are then stored.

Step (8): the azimuth angle is calculated, which includes: obtaining the quaternion calculated after the update in step (7) when measuring the distance of the second target point, and calculating the Euler angles. Specifically:

### Roll Angle:

$$\begin{matrix}roll = - a sin ( rM a t [ 2 ] [ 0 ] ) \times 57.3 \\ = - a sin ( 2 \times {q}_{1} \times {q}_{3} - 2 \times {q}_{0} \times {q}_{2} ) \times 57.3\end{matrix}$$

### Pitch Angle:

$$\begin{matrix}pitch = a tan 2 ( r M a t [ 2 ] [ 1 ] , rMa t [ 2 ] [ 2 ] ) \times 57.3 \\ = a tan 2 ( 2 \times {q}_{2} \times {q}_{3} + 2 \times {q}_{0} \times {q}_{1} , 1 - 2 \times {q}_{1} \times {q}_{1} - 2 \times {q}_{2} \times {q}_{2} ) \times 57.3\end{matrix}$$

### Yaw Angle:

$$\begin{matrix}yaw = a tan 2 ( r M a t [ 1 ] [ 0 ] , rMa t [ 0 ] [ 0 ] ) \times 57.3 \\ a tan 2 ( 2 \times {q}_{1} \times {q}_{2} + 2 \times {q}_{0} \times {q}_{3} , 1 - 2 \times {q}_{2} \times {q}_{2} - 2 \times {q}_{3} \times {q}_{3} ) \times 57.3\end{matrix}$$

The resulting yaw angle is the azimuth angle θ₃.

The specific method for calculating the distance between the first and second target points using trigonometric functions includes the following steps.

The space coordinate system (X, Y, Z) is used to construct the reference coordinate system. The reference coordinate system is established by using the horizontal distance D₁′ between the laser rangefinder and the first target point, the horizontal distance D₂′ between the laser rangefinder and the second target point, and the horizontal distance D₃′ between the first and second target points. The distance D₁ and the first pitch angle θ₁ between the laser rangefinder and the first target point are mapped into the reference coordinate system. Similarly, the distance D₂ and the second pitch angle θ₂ between the laser rangefinder and the second target point are also mapped. Based on trigonometric calculations, the following equations are derived:
the horizontal distance between the laser rangefinder and the first target point: D₁′=D₁·cos(θ₁);
the vertical distance between the first target point and the plane coordinates: D_{H1}=D₁·sin(θ₁);
the horizontal distance between the laser rangefinder and the second target point: D₂′=D₂·cos(θ₂);
the vertical distance between the second target point and the plane coordinates: D_{H2}=D₂·sin(02).

In the reference coordinate system, the angle between the horizontal distances D₁′ and D₂′ from the laser rangefinder to the first target point and from the laser rangefinder to the second target point is the azimuth angle θ₃. The horizontal distance between the first and second target points, D₃′, can be calculated using trigonometric functions:

$${D}_{3}^{′} = \sqrt{{D}_{1}^{′2} + {D}_{2}^{′2} - 2 {D}_{1}^{′} {D}_{2}^{′} COS {θ}_{3}}$$

Since there may be a height difference ΔD between the first and second target points, the height difference ΔD, the horizontal distance D₃′ between the first and second target points, and the actual distance D₃ between the first and second target points form a right triangle. According to the properties of the right triangle, the actual distance D₃ between the first and second target points is calculated using the Pythagorean theorem:

$${D}_{3} = \sqrt{{D}_{3}^{′2} + Δ {D}^{2}}$$

$$Where Δ D = \vert {D}_{H 1} - {D}_{H 2} \vert .$$

### Embodiment 3

As shown in FIG. 3, a handheld laser rangefinder includes: a laser ranging module 10, a gyroscope module 20, an accelerometer module 30, and a processor module 40, the method for measuring the distance between two points in space is embedded in the processor module, and the processor module is used to measure the distance between two points in space.

In an embodiment, the laser ranging module 10 may include a laser emitter 11, a laser receiver 12, and a signal processing circuit 13. The gyroscope module 20 may include the gyroscope 21. The accelerometer module 30 may include the accelerometer 31. The processor module 40 may include a processor 41.

In summary, the method in the aforementioned embodiment provides the accelerometer and the gyroscope in the handheld laser rangefinder to obtain the acceleration measured by the accelerometer and the angular velocity obtained by the gyroscope. By combining the angular velocity and acceleration, before calculating the azimuth angle, the coordinate system of the handheld laser rangefinder is transformed into the reference coordinate system. The coordinate system of the handheld laser rangefinder is obtained from the acceleration sensor, and the acceleration values obtained from the acceleration sensor are used to calculate the angle between the handheld laser rangefinder's coordinate system and the reference coordinate system. The rotation matrix is then used to obtain the values of the handheld laser rangefinder in the reference coordinate system. After obtaining the values in the reference coordinate system, the yaw angle is mapped through coordinate transformation into the reference coordinate system to obtain the azimuth angle in the reference coordinate system. Then, by combining the distance measured by the laser rangefinder with the azimuth angle and other data, the distance between the two points in space is calculated. This method effectively addresses the issue of inaccurate azimuth angles and large measurement errors caused by non-horizontal positioning of the body of the handheld laser rangefinder, improving the measurement accuracy of the handheld laser rangefinder. The handheld laser rangefinder mentioned in the disclosure is not limited to portable handheld laser rangefinders but can also be applied to other devices with laser ranging functionality, such as laser rangefinder telescopes.

The above embodiment is provided to illustrate the technical solution of the disclosure and is not intended to limit it. Although the disclosure has been described in detail with reference to the above embodiments, those skilled in the art will understand that they may modify the technical solutions described in the above embodiments or equivalently replace some of the technical features without departing from the spirit and scope of the technical solutions of the disclosure.

What is claimed is:

1. A method for measuring a distance between two points in space using a handheld laser rangefinder, comprising:
step 1: configuring an accelerometer and a gyroscope within the handheld laser rangefinder, and obtaining angular velocity and translational acceleration of the handheld laser rangefinder during measurement via the accelerometer and the gyroscope;
step 2: aiming the handheld laser rangefinder at a first target point and determining a distance between the handheld laser rangefinder and the first target point: a first measured distance;
step 3: rotating the handheld laser rangefinder toward a second target point and determining a distance between the handheld laser rangefinder and the second target point: a second measured distance;
step 4: during the rotation of the handheld laser rangefinder, acquiring angular velocity data and acceleration data in real time from the gyroscope and the accelerometer, integrating the angular velocity data and the acceleration data, and transforming a coordinate system of the handheld laser rangefinder into a reference coordinate system;
wherein the coordinate system of the handheld laser rangefinder is obtained from the accelerometer; acceleration values are obtained from the accelerometer to calculate an angle between the coordinate system of the handheld laser rangefinder and the reference coordinate system; a rotation matrix is used to derive values of the handheld laser rangefinder in the reference coordinate system, including a first pitch angle and a first yaw angle of the first target point, and a second pitch angle and a second yaw angle of the second target point; a difference between the first yaw angle and the second yaw angle is calculated as an azimuth angle; and after obtaining values of the reference coordinate system, the first pitch angle, the second pitch angle, and the azimuth angle are mapped into the reference coordinate system through coordinate transformation to obtain a first pitch angle, a second pitch angle, and an azimuth angle in the reference coordinate system; and
step 5: calculating, using trigonometric principles, a distance between the first target point and the second target point.

2. The method according to claim 1, wherein step 4 comprises:
S1: reading gyroscope data from the gyroscope and accelerometer data from the accelerometer, and storing the gyroscope data and the accelerometer data in a register;
S2: processing the accelerometer data;
S3: processing the gyroscope data;
S4: compensating the gyroscope using the accelerometer data;
S5: calculating a quaternion;
S6: calculating a rotation matrix r to obtain calculated rotation matrix data;
S7: feeding the calculated rotation matrix data back to S4 and repeating S4 to S6 to calculate multiple rotation matrix data results, and storing the multiple rotation matrix data results;
S8: obtaining a quaternion when measuring the first target point and calculating Euler angles of the first target point, including a first roll angle, the first pitch angle, and the first yaw angle;
obtaining a quaternion updated by S7 when measuring the second target point and calculating Euler angles of the second target point, including a second roll angle, the second pitch angle, and the second yaw angle; and
determining a difference between the first yaw angle and the second yaw angle as the azimuth angle.

3. The method according to claim 2, wherein S4 comprises:
S41: calculating a difference between a direction read by the accelerometer and a direction of gravitational acceleration using a vector cross-product method;
S42: multiplying the calculated difference from S41 by an integration constant and performing error accumulation; and
S43: correcting a gyroscope drift using a cross-product error to offset a drift in gyroscope readings.

4. The method according to claim 2, wherein S5 comprises:
S51: integrating a discretized form of a quaternion kinematic equation using a first-order approximation algorithm to obtain the quaternion; and
S52: uniting the quaternion using a normalization algorithm.

5. The method according to claim 1, wherein step 5 comprises:
(a) constructing a reference coordinate system using a spatial coordinate system (X, Y, Z) and mapping obtained measurement data into the reference coordinate system;
(b) calculating a horizontal distance between the handheld laser rangefinder and the first target point, a vertical distance of the first target point relative to plane coordinates, a horizontal distance between the handheld laser rangefinder and the second target point, and a vertical distance of the second target point relative to plane coordinates;
(c) determining the azimuth angle in the reference coordinate system as an angle between the horizontal distance between the handheld laser rangefinder and the first target point and the horizontal distance between the handheld laser rangefinder and the second target point, and calculating a horizontal distance between the first target point and the second target point using trigonometric functions; and
(d) calculating a spatial distance between the first target point and the second target point based on a height difference between the first target point and the second target point.

6. The method according to claim 5, wherein step (a) comprises:
mapping the horizontal distance between the handheld laser rangefinder and the first target point, the horizontal distance between the handheld laser rangefinder and the second target point, the horizontal distance between the first target point and the second target point, the first measured distance and the first pitch angle between the handheld laser rangefinder and the first target point, and the second measured distance and the second pitch angle between the handheld laser rangefinder and the second target point into the reference coordinate system.

7. The method according to claim 5, wherein step (b) comprises:
based on the first measured distance and the first pitch angle between the handheld laser rangefinder and the first target point, and the second measured distance and the second pitch angle between the handheld laser rangefinder and the second target point, calculating, using the trigonometric functions, the horizontal distance between the handheld laser rangefinder and the first target point, the vertical distance of the first target point relative to the plane coordinates, the horizontal distance between the handheld laser rangefinder and the second target point, and the vertical distance of the second target point relative to the plane coordinates.

8. The method according to claim 5, wherein step (d) comprises:
calculating the spatial distance between the first target point and the second target point based on the following:
the height difference between the first target point and the second target point,
the horizontal distance between the first target point and the second target point, and
the distance between the first target point and the second target point;
wherein the height difference, the horizontal distance, and the distance between the first and second target points form a right triangle, and the spatial distance is calculated according to properties of the right triangle.

9. The method according to claim 2, wherein S2 comprises:
performing zero drift calibration on the accelerometer data to obtain calibrated accelerometer data;
normalizing the calibrated accelerometer data by multiplying the calibrated accelerometer data by gravitational acceleration to obtain normalized accelerometer data; and
performing filtering on the normalized accelerometer data to obtain processed accelerometer data, and storing the processed accelerometer data.

10. The method according to claim 2, wherein S3 comprises:
performing zero drift calibration on the gyroscope data to obtain calibrated gyroscope data;
normalizing the calibrated gyroscope data by converting angular velocity units of the gyroscope from radians per second to degrees per second to obtain normalized gyroscope data; and
performing filtering on the normalized gyroscope data to obtain processed gyroscope data, and storing the processed gyroscope data.

11. A handheld laser rangefinder, comprising:
a laser ranging module,
a gyroscope module,
an accelerometer module, and
a processor module;
wherein the processor module is embedded with the method for measuring the distance between the two points in space according to claim 1, and configured to measure the distance between the two points in space.

12. The handheld laser rangefinder according to claim 11, wherein step 4 comprises:
S1: reading gyroscope data from the gyroscope and accelerometer data from the accelerometer, and storing the gyroscope data and the accelerometer data in a register;
S2: processing the accelerometer data;
S3: processing the gyroscope data;
S4: compensating the gyroscope using the accelerometer data;
S5: calculating a quaternion;
S6: calculating a rotation matrix r to obtain calculated rotation matrix data;
S7: feeding the calculated rotation matrix data back to S4 and repeating S4 to S6 to calculate multiple rotation matrix data results, and storing the multiple rotation matrix data results;
S8: obtaining a quaternion when measuring the first target point and calculating Euler angles of the first target point, including a first roll angle, the first pitch angle, and the first yaw angle;
obtaining a quaternion updated by S7 when measuring the second target point and calculating Euler angles of the second target point, including a second roll angle, the second pitch angle, and the second yaw angle; and
determining a difference between the first yaw angle and the second yaw angle as the azimuth angle.

13. The handheld laser rangefinder according to claim 12, wherein S2 comprises:
performing zero drift calibration on the accelerometer data to obtain calibrated accelerometer data;
normalizing the calibrated accelerometer data by multiplying the calibrated accelerometer data by gravitational acceleration to obtain normalized accelerometer data; and
performing filtering on the normalized accelerometer data to obtain processed accelerometer data, and storing the processed accelerometer data.

14. The handheld laser rangefinder according to claim 12, wherein S4 comprises:
S41: calculating a difference between a direction read by the accelerometer and a direction of gravitational acceleration using a vector cross-product method;
S42: multiplying the calculated difference from S41 by an integration constant and performing error accumulation; and
S43: correcting a gyroscope drift using a cross-product error to offset a drift in gyroscope readings.

15. The handheld laser rangefinder according to claim 12, wherein S5 comprises:
S51: integrating a discretized form of a quaternion kinematic equation using a first-order approximation algorithm to obtain the quaternion; and
S52: uniting the quaternion using a normalization algorithm.

16. The handheld laser rangefinder according to claim 11, wherein step 5 comprises:
(a) constructing a reference coordinate system using a spatial coordinate system (X, Y, Z) and mapping obtained measurement data into the reference coordinate system;
(b) calculating a horizontal distance between the handheld laser rangefinder and the first target point, a vertical distance of the first target point relative to plane coordinates, a horizontal distance between the handheld laser rangefinder and the second target point, and a vertical distance of the second target point relative to plane coordinates;
(c) determining the azimuth angle in the reference coordinate system as an angle between the horizontal distance between the handheld laser rangefinder and the first target point and the horizontal distance between the handheld laser rangefinder and the second target point, and calculating a horizontal distance between the first target point and the second target point using trigonometric functions; and
(d) calculating a spatial distance between the first target point and the second target point based on a height difference between the first target point and the second target point.

17. The handheld laser rangefinder according to claim 16, wherein step (a) comprises:
mapping the horizontal distance between the handheld laser rangefinder and the first target point, the horizontal distance between the handheld laser rangefinder and the second target point, the horizontal distance between the first target point and the second target point, the first measured distance and the first pitch angle between the handheld laser rangefinder and the first target point, and the second measured distance and the second pitch angle between the handheld laser rangefinder and the second target point into the reference coordinate system.

18. The handheld laser rangefinder according to claim 16, wherein step (b) comprises:
based on the first measured distance and the first pitch angle between the handheld laser rangefinder and the first target point, and the second measured distance and the second pitch angle between the handheld laser rangefinder and the second target point, calculating, using the trigonometric functions, the horizontal distance between the handheld laser rangefinder and the first target point, the vertical distance of the first target point relative to the plane coordinates, the horizontal distance between the handheld laser rangefinder and the second target point, and the vertical distance of the second target point relative to the plane coordinates.

19. The handheld laser rangefinder according to claim 16, wherein step (d) comprises:
calculating the spatial distance between the first target point and the second target point based on the following:
the height difference between the first target point and the second target point,
the horizontal distance between the first target point and the second target point, and
the distance between the first target point and the second target point;
wherein the height difference, the horizontal distance, and the distance between the first and second target points form a right triangle, and the spatial distance is calculated according to properties of the right triangle.

20. The handheld laser rangefinder according to claim 11, wherein the gyroscope module comprises the gyroscope, the accelerometer module comprises the accelerometer, the laser ranging module comprises a laser emitter, a laser receiver and a signal processing circuit, and the processor module comprises: a processor.
